(19) United States
(12) Patent Application Publication
(10) Pub. No.: US 2009/0274438 A1
(43) Pub. Date: Nov. 5, 2009

(54) VIDEO PROCESSING APPARATUS AND METHOD FOR PROCESSING VIDEO DATA

(76) Inventors: Sayoko TANAKA, Tokyo (JP); Yoshihisa KIZUKA, Tokyo (JP); Hitoshi SAIJO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/366,690

(22) Filed: Feb. 6, 2009

(30) Foreign Application Priority Data
Apr. 30, 2008 (JP) P2008-118221

(51) Int. Cl. H04N 5/91

(52) U.S. Cl. 386/95; 386/E05.003

(57) ABSTRACT

A video processing apparatus includes: a memory; a storage unit; and a processor that operates to: acquire a reproduction end time from pre-conversion video data stored in the memory; perform stream data conversion processing on the pre-conversion video data stored in the memory to generate stream-data-converted video data on a unit video data basis after acquiring the reproduction end time; generate converted video data by inserting spurious management information including dummy data into the stream-data-converted video data; generate a time map indicating reproduction time information including the reproduction end time of the converted video data; write the converted video data and the time map to the storage unit; generate management information based on the reproduction end time and the time map written in the storage unit; and overwrite the spurious management information with the management information.

### CROSS REFERENCE TO RELATED APPLICATION(S)

The present disclosure relates to the subject matters contained in Japanese Patent Application No. 2008-118221 filed on Apr. 30, 2008, which are incorporated herein by reference in its entirety.

### FIELD

The present invention relates to a video processing apparatus and a method for processing a video data.

### BACKGROUND

There is known a video processing apparatus in which a format conversion is performed at high speed when video data, which conforms to the DVD-VR format and is stored in a storage unit, is copied onto a DVD that conforms to the DVD-Video format. An example of such apparatus is disclosed in JP-A-2005-141788.

In the video processing apparatus disclosed in the publication, when video data is stored in the storage unit, instead of RDI_PCK (real time data information pack) of video data that was generated according to the DVD-VR format, VOBU_{—}1STREF_EA, VOBU_{—}2NDREF_EA, VOBU_{—}3RDREF_EA, A_SYNCA are stored at corresponding positions of NV_PCK (navigation pack). And an RDI/DSI pack in which data regions that exist in NV_PCK but does not exist in RDI_PCK are reserved is recorded. Accordingly, when converting video data that conforms to the DVD-VR format into video data that conforms to the DVD-Video format, NV_PCK can be generated merely by calculating part of data in NV_PCK. Therefore, the amount of processing that is required for the format conversion is reduced and hence the copying speed can be increased.

However, in the conventional video processing apparatus, RDI/DSI packs needs to be generated in recording video data in the storage unit. Therefore, when converting video data not having RDI/DSI packs into video data that conforms to the DVD-Video format, it is necessary to generate all data of NV_PCK. In this case, the copying speed cannot be increased.

### SUMMARY

One of objects of the present invention is to provide a video processing apparatus and a method for processing a video image capable of increasing the speed of format conversion of video data without preparing special video data.

According to a first aspect of the present invention, there is provided a video processing apparatus including: a memory that is configured to store pre-conversion video data; a storage unit that is configured to store data; and a processor that operates to: acquire a reproduction end time from the pre-conversion video data stored in the memory; perform stream data conversion processing on the pre-conversion video data stored in the memory to generate stream-data-converted video data on a unit video data basis after acquiring the reproduction end time; generate converted video data by inserting spurious management information including dummy data into the stream-data-converted video data; generate a time map indicating reproduction time information including the reproduction end time of the converted video data; write the converted video data and the time map to the storage unit; generate management information based on the reproduction end time and the time map written in the storage unit; and overwrite the spurious management information with the management information.

According to a second aspect of the present invention, there is provided a method for processing video data, the method including: acquiring a reproduction end time from pre-conversion video data; performing stream data conversion processing on the pre-conversion video data to generate stream-data-converted video data on a unit video data basis; generating converted video data by inserting spurious management information including dummy data into the stream-data-converted video data; generating a time map indicating reproduction time information including the reproduction end time of the converted video data; writing the converted video data and the time map to a storage unit; generating management information based on the reproduction end time and the time map written in the storage unit; and overwriting the spurious management information with the management information.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view of a video processing apparatus according to an embodiment of the invention.

FIG. 2 is a block diagram showing a configuration of the video processing apparatus according to the embodiment of the invention.

FIGS. 3A and 3B are schematic diagrams of pre-conversion video data and video data recorded on an optical medium according to the embodiment of the invention, respectively.

FIG. 4 is a schematic diagram showing an example video processing operation of the video processing apparatus according to the embodiment of the invention.

FIGS. 5A and 5B are schematic diagrams showing an example video processing operation of the video processing apparatus according to the embodiment of the invention, wherein FIG. 5A shows an ordinary video processing operation, and wherein FIG. 5B shows a video processing operation which is performed around a reproduction end time.

FIGS. 6A and 6B are schematic diagrams showing an example video processing operation of the video processing apparatus according to the embodiment of the invention, wherein FIG. 6A shows pre-conversion video data, and wherein FIG. 6B shows -converted video data.

FIG. 7 is a flowchart showing an example operation of the video processing apparatus according to the embodiment of the invention.

### DETAILED DESCRIPTION OF THE EMBODIMENTS

Hereinafter, embodiments of the invention will be described. In the following description, the same or similar components will be referenced by the same reference numerals, and detailed description thereof will be omitted.

A video processing apparatus according to an embodiment of the present invention will be hereinafter described in detail with reference to the drawings.

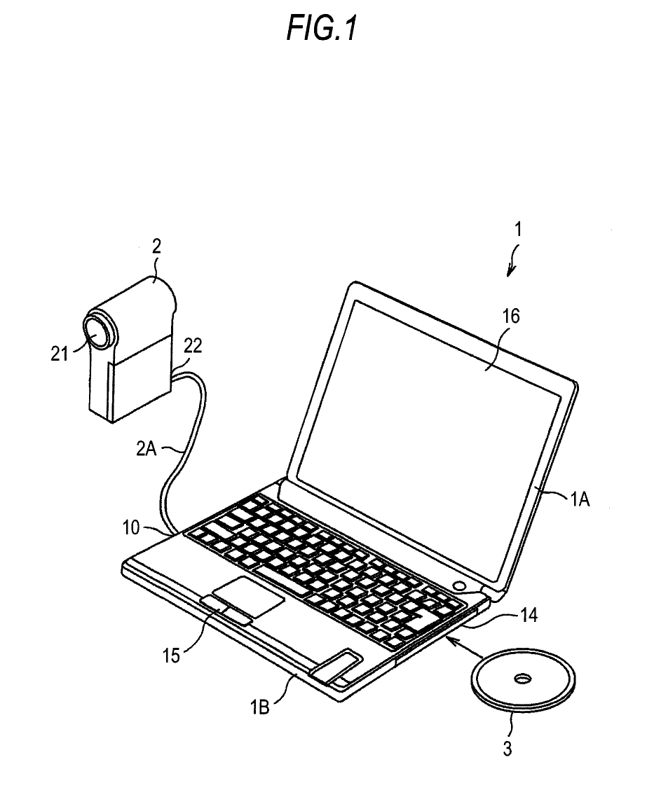

FIG. 1 is a perspective view of the video processing apparatus according to the embodiment of the invention.

The video processing apparatus 1 is connected to a video recorder 2 via a USB (universal serial bus) cable 2A. The video processing apparatus 1 can thus receive, by communicating with the video recorder 2, video information produced by the video recorder 2 by capturing and recording a video image on a recording medium such as an optical medium 3. In recording video information received from the video recorder 2 on the optical medium 3, the video processing apparatus 1 converts the video information into the DVD-Video format which is compatible with the optical medium 3.

The video processing apparatus 1 is provided with an upper body 1A and a lower body 1B, and the upper body 1A is connected to the lower body 1B via hinges so as to be opened and closed with respect to the lower body 1B. The upper body 1A has a display device 16 such as a liquid crystal display panel which displays texts and images. The lower body 1B is provided with electronic components such as a CPU (central processing unit) and an HDD (hard disk drive) and has an optical disc drive 14 capable of writing and reading data to and from the optical medium 3, such as a DVD (digital versatile disc), and a USB terminal 10 to be connected to an external device via a USB cable 2A. The lower body 1B also has, on its top face, a user interface 15 which consists of a keyboard and a pointing device and allows the user to input commands.

The video recorder 2 is equipped with an imaging unit 21 which is composed of an optical system (plural lenses) and an imaging device such as a CCD (charge-coupled device) and a USB terminal 22 to be connected to an external device via a USB cable 2A. The video recorder 2 records video data produced by capturing in a storage unit that is provided inside the main body. The video data is pre-conversion video data and is recorded as data that conforms to such a format as MPEG-2.

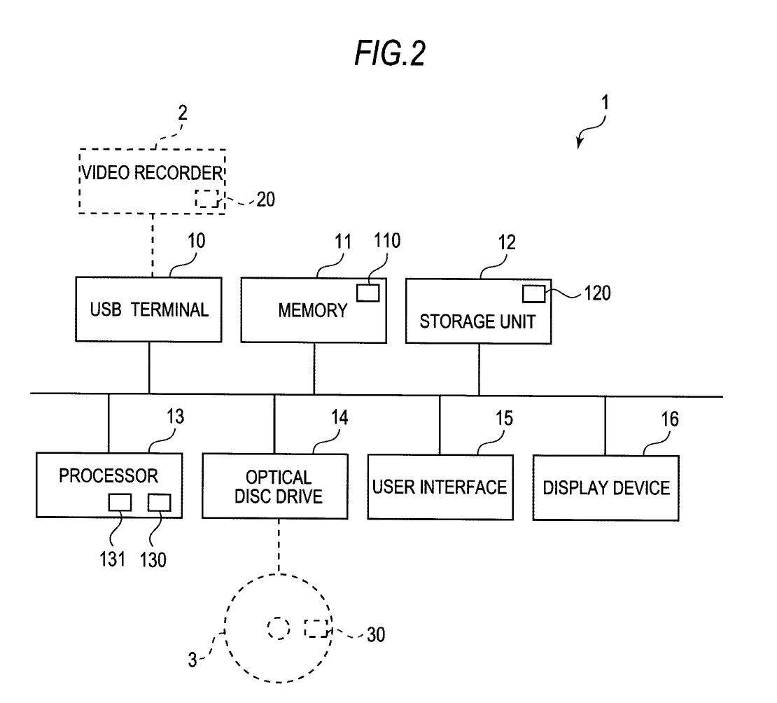

FIG. 2 is a block diagram showing the configuration of the video processing apparatus 1 according to the embodiment of the invention.

The video processing apparatus 1 is equipped with the USB terminal 10 through which to exchange data with the video recorder 2 via an USB cable 2A inserted therein, a memory 11 for storing information temporarily and assisting processing of each unit, a storage unit 12 such as an HDD for storing information in such a manner that it can be read and overwritten, a processor 13 for controlling operation of each unit and running a program, the optical disc drive 14 capable of writing and reading information to and from an optical medium such as a DVD, the user interface 15 including a track pad and a keyboard which consists of plural switches that are assigned respective manipulation functions, and the display device 16 in which a text, an image, etc. are displayed on a liquid crystal display panel.

The USB terminal 10 receives pre-conversion video data 20 that is stored in the storage unit of the video recorder 2 connected thereto.

The memory 11 temporarily stores, as under-conversion video data 110, the pre-conversion video data 20 received through the USB terminal 10.

The storage unit 12 stores converted video data 120 that is generated by converting the format of the pre-conversion video data 20.

The processor 13 runs a video conversion program 130 for storing, in the storage unit 12, converted video data 120 that is generated by format-converting the under-conversion video data 110 and a video data writing program 131 for writing the converted video data 120 to the optical medium 3 and deleting, from the storage unit 12, the converted video data 120 that has been written to the optical medium 3.

The optical disc drive 14 writes, as video data 30, the converted video data 120 to the optical medium 3 that is inserted into the optical disc drive 14.

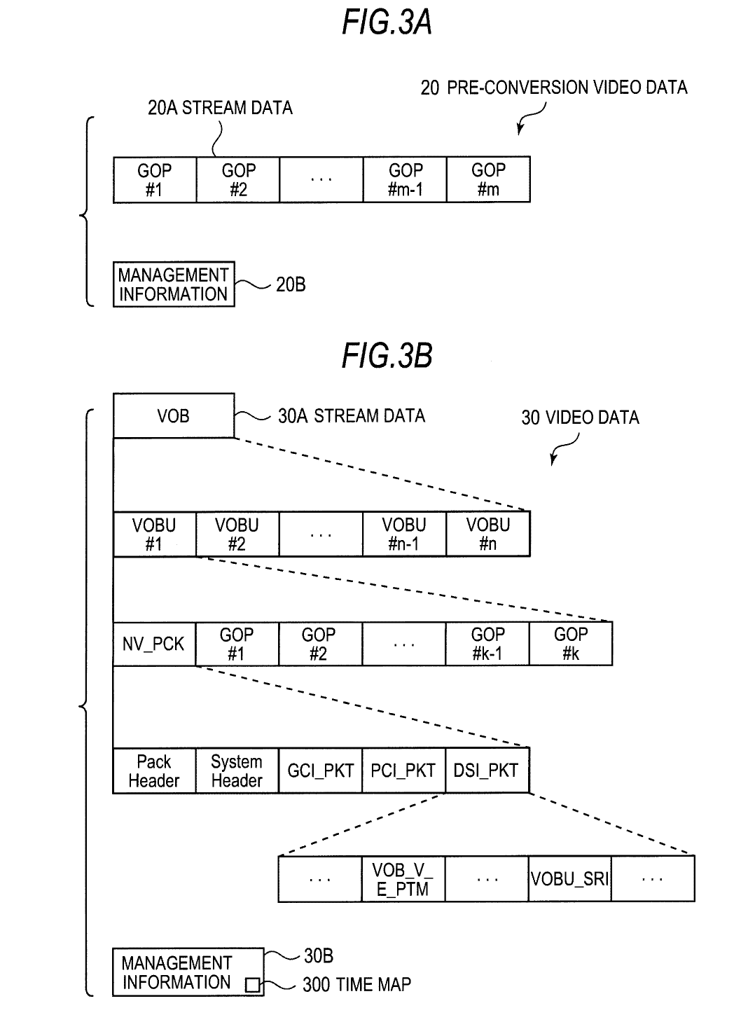

FIGS. 3A and 3B are schematic diagrams of pre-conversion video data 20 and video data 30 according to the embodiment, respectively.

The pre-conversion video data 20, which is video data that conforms to such a format as MPEG-2, has stream data 20A for display of an image and management information 20B indicating the details of the image (see FIG. 3A). The stream data 20A consists of plural GOPs (groups of pictures). The GOP is unit video data having an I frame (reference frame), a P frame which is a difference from the I frame, and plural B frames which are differences from preceding and following frames. The management information 20B includes header information, meta-data, and other information of the pre-conversion video data 20.

The video data 30, which is video data that conforms to the DVD-Video format standard, has stream data 30A for display of an image and management information 30B indicating the details of the image (see FIG. 3B). The stream data 30A consists of plural VOBUs (video object units). Each VOBU, which has a reproduction time of 0.4 to 1.0 sec, has NV_PCK at the head, which is followed by plural GOPs.

The NV_PCK, which is management information in the stream data 30, has control information relating to reproduction display and control information relating to access and also has, as data, Pack Header, System Header, GCI_PKT, PCI_PKT, and DSI_PKT. The DSI_PKT (data search information packet) includes VOB_V_E_PTM which indicates a reproduction end time of the VOB and VOBU_SRI which indicates addresses of VOBUs that exist in 120-second periods before and after the VOBU that includes the NV_PCK.

The management information 30B has a time map 300 which indicates a reproduction time of the stream data 30A in addition to header information, meta-data, and other information of the video data 30.

The video data 30 is the converted video data 120 as written to the optical medium 3. Therefore, the converted video data 120 has the same structure as the video data 30. Stream data 120A and management information 120B of the converted video data 120 have the same structures as the stream data 30A and the management information 30B, respectively.

An example of the operation of the video processing apparatus 1 according to the embodiment of the invention will be described below with reference to the drawings.

First, the video conversion program 130 executes a memory reading-in step of reading stream data 20A into the memory 11, a stream data conversion step of performing stream data conversion processing on the read-in stream data 20A on a GOP-by-GOP basis and generating GOPs in each VOBU of stream data 120A, an NV_PCK generating step of generating NV_PCK at the head of each VOBU, and an NV_PCK setting step of setting the NV_PCKs. Conventionally, the NV_PCK generating step and the NV_PCK setting step are executed after completion of the stream data conversion step. In contrast, in the invention, the stream data conversion step, the NV_PCK generating step, and the NV_PCK setting step are executed simultaneously.

However, among the data included in the DSI_PKT, the VOB_V_E_PTM which indicates a reproduction end time of the VOB is not obtained until the last GOP of the stream data 20A is read and a reproduction time is acquired. Among the data included in the DSI_PKT, the VOBU_SRI which indicates addresses of VOBUs that exist in 120-sec periods before and after the VOBU that includes the NV_PCK is not obtained until addresses of VOBUs of the stream data 120A are determined by performing stream data conversion processing on a portion of the stream data 20A that is located 120-second after the VOBU that includes the NV_PCK.

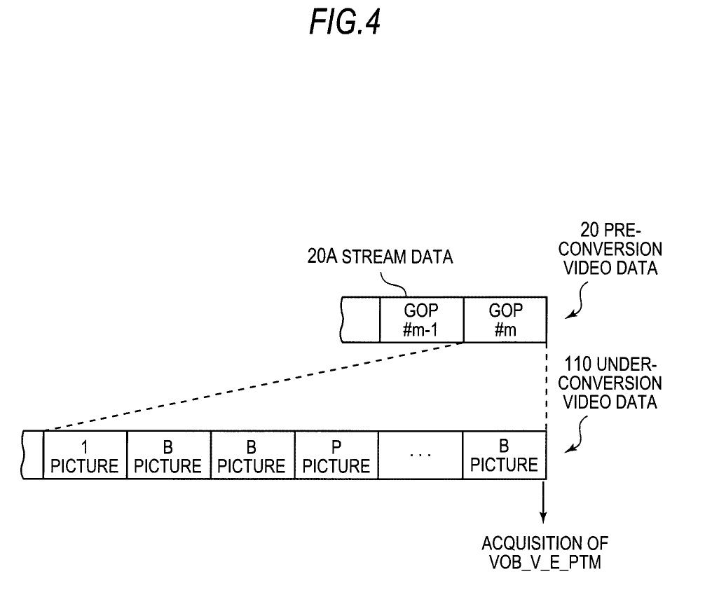

FIG. 4 is a schematic diagram showing an example video processing operation of the video processing apparatus 1 according to the embodiment.

First, before executing the stream data conversion step and the NV_PCK generating step, the video conversion program 130 acquires information that is necessary for setting VOB_V_E_PTM. The video conversion program 130 reads GOP #m which is the last GOP of pre-conversion video data 20 into the memory 11 as under-conversion video data 110. Then, the video conversion program 130 acquires a reproduction time by developing the GOP #m frame by frame and acquires VOB_V_E_PTM as a reproduction end time.

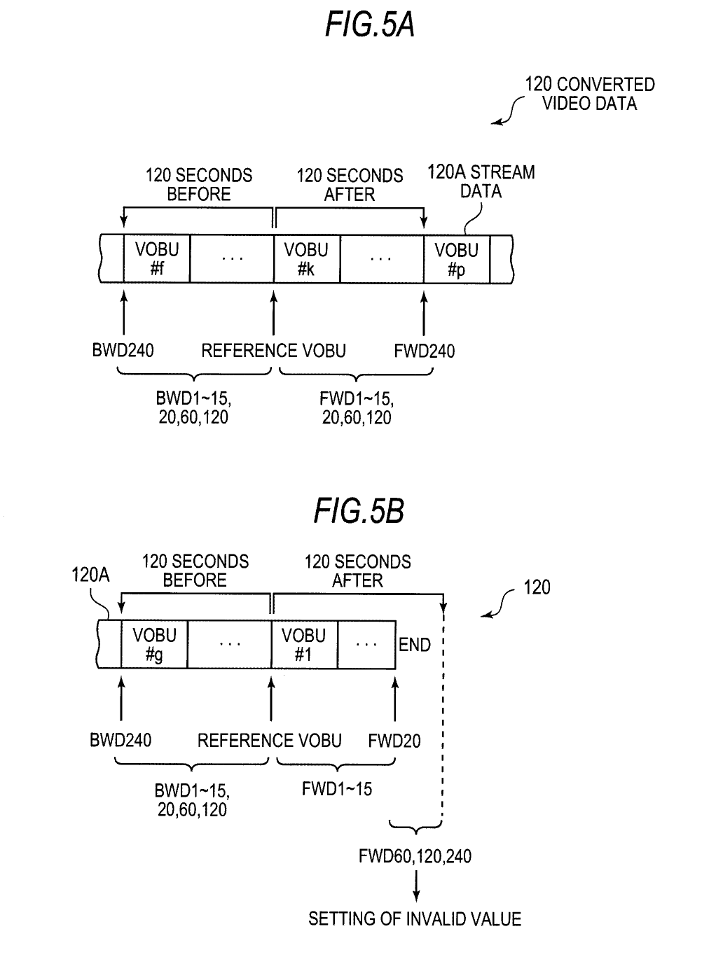

FIGS. 5A and 5B are schematic diagrams showing an example video processing operation of the video processing apparatus 1 according to the embodiment of the invention; FIG. 5A shows an ordinary video processing operation and FIG. 5B shows a video processing operation which is performed around a reproduction end time.

After acquiring the reproduction end time (see FIG. 4), the video conversion program 130 starts the NV_PCK generating step at the same time as the stream data conversion step. However, as shown in FIG. 5A, to acquire VOBU_SRI of NV_PCK to be generated, addresses of VOBUs that exist in 120-sec periods before and after the VOBU concerned. Therefore, parallel with the execution of the stream data conversion step, the video conversion program 130 executes the NV_PCK setting step of setting dummy VOBU_SRI, writing stream data 120A in the storage unit 12 as converted video data 120 (as temporary data), calculating correct VOBU_SRI when stream data conversion processing of a time point 120 seconds later is completed, and setting NV_PCK again and overwriting the stream data 120A with new data.

The VOBU_SRI has addresses in units of 0.5 sec and has addresses, on the time map 300, of VOBUs corresponding to time points that are 120 seconds earlier, 60 seconds earlier, 30 seconds earlier, 10 seconds earlier, and 7.5 to 0.5 second earlier (BWD240, 120, 60, 20, and 15-1) and 0.5-7.5 seconds later, 10 seconds later, 30 seconds later, 60 seconds later, and 120 seconds later (FWD1-15, 20, 60, 120, and 240).

As shown in FIG. 5B, when the time to the reproduction end time has become shorter than 120 seconds, the video conversion program 130 generates NV_PCK in such a manner as to set addresses corresponding to time points after the reproduction end time, that is, addresses corresponding to FWD 60, 120, and 240, to an invalid value indicating that no address exists.

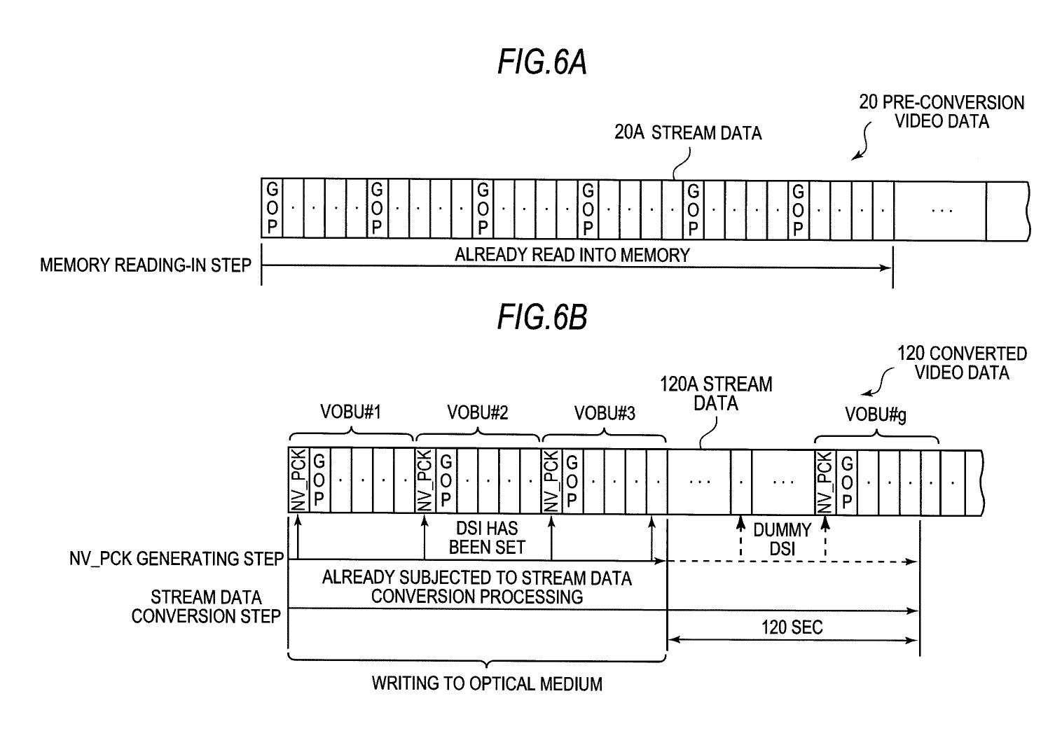

FIGS. 6A and 6B are schematic diagrams showing an example video processing operation of the video processing apparatus 1 according to the embodiment of the invention; FIG. 6A shows pre-conversion video data and FIG. 6B shows converted video data.

First, as shown in FIG. 6A, the video conversion program 130 reads stream data 20A into the memory 11 by a prescribed amount of data at a time and performs stream data conversion processing sequentially from the head GOP. Then, as shown in FIG. 6B, while performing the stream data conversion processing, the video conversion program 130 generates NV_PCKs and inserts them into respective VOBUs of stream data 120 at the heads. However, since stream data conversion processing on a 120-second later portion has not completed yet, first the video conversion program 130 writes stream data 120A in such a manner as to insert dummy data (e.g., “0”) into VOBU_SRIs of DSI_PKTs.

Then, when the 120-second later portion of the stream data 20A has been converted into a corresponding portion of the stream data 120A, the video conversion program 130 calculates VOBU_SRIs of DSI_PKTs and overwrites the DSI_PKTs of NV_PCKs with the new ones. That is, the setting of DSI_PKTs is completed to the stream-data-conversion-completed NV_PKT that is 120 seconds before the reproduction time point and the NV_PCKs are overwritten.

VOBUs for which DSI_PKT of NV_PCK has been set are completed as portions of the converted video data 120. Therefore, the video data writing program 131 writes them sequentially to the optical medium 3 as portions of stream data 30A and deletes, from the storage unit 12, the portion, corresponding to the stream data 30A that has been written to the optical medium 3, of the stream data 120A.

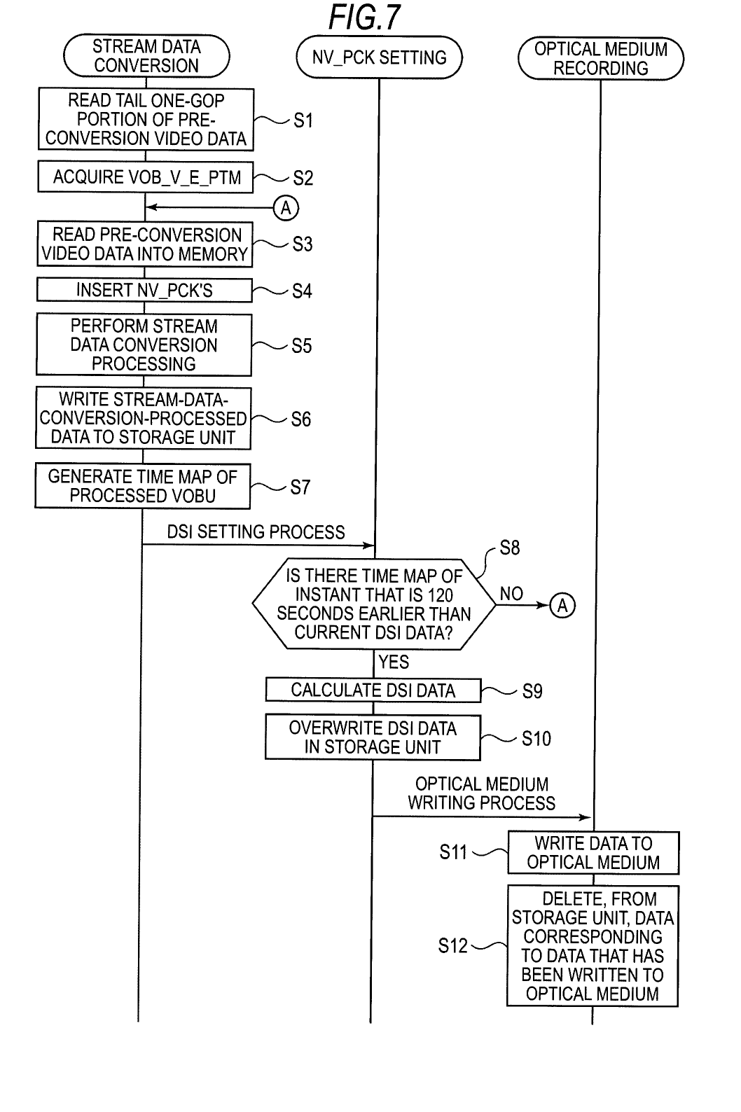

FIG. 7 is a flowchart showing an example operation of the video processing apparatus 1 according to the embodiment.

First, at step S1, the video conversion program 130 reads a tail one-GOP portion of pre-conversion video data 20 into the memory 11 as under-conversion video data 110. At step S2, the video conversion program 130 acquires VOB_V_E_PTM by developing, frame by frame, the under-conversion video data 110 stored in the memory 11.

At step S3, the video conversion program 130 reads the pre-conversion video data 20 by a prescribed amount of data at a time (memory reading-in step). At step S4, the video conversion program 130 inserts NV_PCK's into respective VOBUs to generate converted video data 120. In doing so, the video conversion program 130 sets dummy data in VOBU_SRI's of DSI_PCK's.

At step S5, the video conversion program 130 performs stream data conversion processing on the pre-conversion video data 20 GOP by GOP (stream data conversion step). At step S6, the video conversion program 130 writes the NV_PCK and the one-VOBU data that has been subjected to the stream data conversion processing to the storage unit 12 as stream data 120A of converted video data 120. At step S7, the video conversion program 130 acquires a reproduction time from the processed stream data 120A and generates a time map in management information 120B.

Steps S3-S7 are executed repeatedly with a prescribed number of VOBUs processed each time.

Then, the video conversion program 130 moves to the NV_PCK setting step. First, at step S8, the video conversion program 130 checks, by referring to the time map, whether the stream data conversion processing has proceeded to a portion that is located 120 seconds after the NV_PCK being processed. If the stream data conversion processing has not proceeded to such an extent yet (S8: no), the process returns to step S3. If the stream data conversion processing has proceeded to such-an extent (S8: yes), at step S9 the video conversion program 130 acquires addresses of VOBUs of a 120-second earlier instant to a 120-second later instant and calculates VOBU_SRI of DSI data. At step S10, the video conversion program 130 overwrites the DSI data of the NV_PCK (dummy data) stored in the storage unit 12 with the new data.

Steps S8-S10 are executed repeatedly with one VOBU processed each time.

The VOBU whose DSI data has been overwritten at step S10 is complete converted video data. Therefore, at step S11, the video data writing program 131 writes each completed VOBU to the optical medium 3. At step S12, the video data writing program 131 deletes, from the storage unit 12, the data corresponding to the data that has been written to the optical medium 3.

Steps S11 and S12 are executed repeatedly with one VOBU processed each time.

In the above-described embodiment, the generation and setting of NV_PCKs which are conventionally performed after completion of the stream data conversion processing on pre-conversion video data are performed simultaneously with the stream data conversion processing. This shortens the time that is taken by the video processing.

Converted video data 120 is written to the optical medium 3 on a VOBU-by-VOBU basis, and data corresponding to converted video data 120 that has been written to the optical medium 3 is deleted from the storage unit 12. Therefore, the occupied capacity of the storage unit 12 is made smaller than in the conventional case in which converted video data 120 is written to the optical medium 3 after all converted video data 120 has been written to the storage unit 12. In the embodiment, in the minimum case, the occupied capacity of the storage unit 12 is made equal to a 120-second portion of converted video data 120.

As described above in detail, there are provided an apparatus and a method for processing video images, which can increase the speed of format conversion of video data without the need for preparing special video data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video processing apparatus comprising:
a memory that stores pre-conversion video data;
a storage unit that stores data in a manner that the data can be read and overwritten; and
a control unit that performs stream data conversion processing on the pre-conversion video data stored in the memory on a video data unit basis after acquiring a reproduction end time from the pre-conversion video data, generates converted video data by inserting quasi-management information including dummy data, writes the converted video data in the storage unit, generates a time map indicating reproduction time information of the converted video data, writes the time map in the storage unit, generates management information based on the reproduction end time and the time map written in the storage unit, and overwrites the quasi-management information of the converted video data with the management information.

2. The apparatus according to claim 1, wherein the receive control unit reads the pre-conversion video data from an external device; and
stores the pre-conversion video data in the memory.

3. The apparatus according to claim 1, wherein the control unit writes the converted video data onto an external storage medium; and
deletes, from the storage unit, the converted video data that was written to the external storage medium.

4. The apparatus according to claim 1, wherein the management information includes the reproduction end time of the converted video data and address information of the converted video data on the time map.

5. The apparatus according to claim 1, wherein the converted video data conforms to a DVD-Video format and the management information includes VOB_V_E_PTM and VOBU_SRI of NV_PCK.

6. A method for processing video data, the method comprising:
acquiring a reproduction end time from an end position of pre-conversion video data;
generating converted video units by performing stream data conversion processing seqentially on the pre-conversion video data on a video data unit basis;
writing the converted video data unit in a storage unit while inserting quasi-management information including dummy data;
generating a time map indicating reproduction time information of the converted video unit including the reproduction end time of the converted video data;
generating management information based on the reproduction end time and the time map; and
overwriting the quasi-management information with the management information.

7. The method according to claim 6 further comprising:
writing the converted unit video data unit and the overwritten management information that are stored in the storage unit to an external storage medium; and
deleting, from the storage unit, the data and the information corresponding to the converted video data unit and the management information that has been written to the external storage medium.
